(19) United States
(12) Patent Application Publication
(10) Pub. No.: US 2021/0186271 A1
(43) Pub. Date: Jun. 24, 2021

(54) SHOWER DEVICE FOR GROOMING HAIR

(71) Applicant: Jacob LaGuardia, Los Angeles, CA (US)

(72) Inventor: Jacob LaGuardia, Los Angeles, CA (US)

(21) Appl. No.: 17/115,979

(22) Filed: Dec. 9, 2020

Related U.S. Application Data
(60) Provisional application No. 62/952,389, filed on Dec. 22, 2019.

(51) Int. Cl. A47K 3/28; B32B 7/06

(52) U.S. Cl. CPC A47K 3/281; B32B 2405/00; B32B 7/06

(57) ABSTRACT

Disclosed herein are bathroom apparatus for grooming hair. The apparatus includes a base member and a hair gripping device.

### TECHNICAL FIELD

The present disclosure relates generally to a novel bathroom or shower device useful for grooming hair.

### BACKGROUND

In general, when a person showers or bathes, or otherwise combs or grooms their hair, one or more hairs (hair shafts) may be expelled from their scalp. For some people, especially those with long and/or thick hair shafts, this may result in an unwanted mass of hair located in the shower/tub that can clog the drain and/or cause an undesirable hygienic condition.

Accordingly, there is a need for a device and method to prevent this condition and/or assist a person in ameliorating this condition.

### BRIEF DESCRIPTION OF THE DRAWINGS

It is believed that certain embodiments will be better understood from the following description taken in conjunction with the accompanying drawings, which are not necessarily to scale and wherein like reference numbers indicate identical or functionally similar elements through the several views, and wherein:

FIG. 1 is an image showing a side perspective view of a portion of a shower having a shower device of the present disclosure affixed to a wall of the shower, in accordance with one or more aspects and implementations described herein.

FIG. 2A is a side perspective view of a portion of a shower wall and an exploded view of the shower device, in accordance with one or more aspects and implementations described herein.

FIG. 2B is a side elevational sectional view of an adhesive sheet, in accordance with one or more aspects and implementations described herein.

FIG. 3 is a rear view of a shower device of the present disclosure, in accordance with one or more aspects and implementations described herein.

FIG. 4 is an elevational side exploded view of a shower device, in accordance with one or more aspects and implementations described herein.

FIG. 5 is a side perspective exploded view of a shower device, in accordance with one or more aspects and implementations described herein.

FIG. 6 is an image showing a side perspective view of a shower device, in accordance with one or more aspects and implementations described herein.

FIG. 7 is an image showing a front view of a shower device having hair affixed thereto, in accordance with one or more aspects and implementations described herein.

### DESCRIPTION

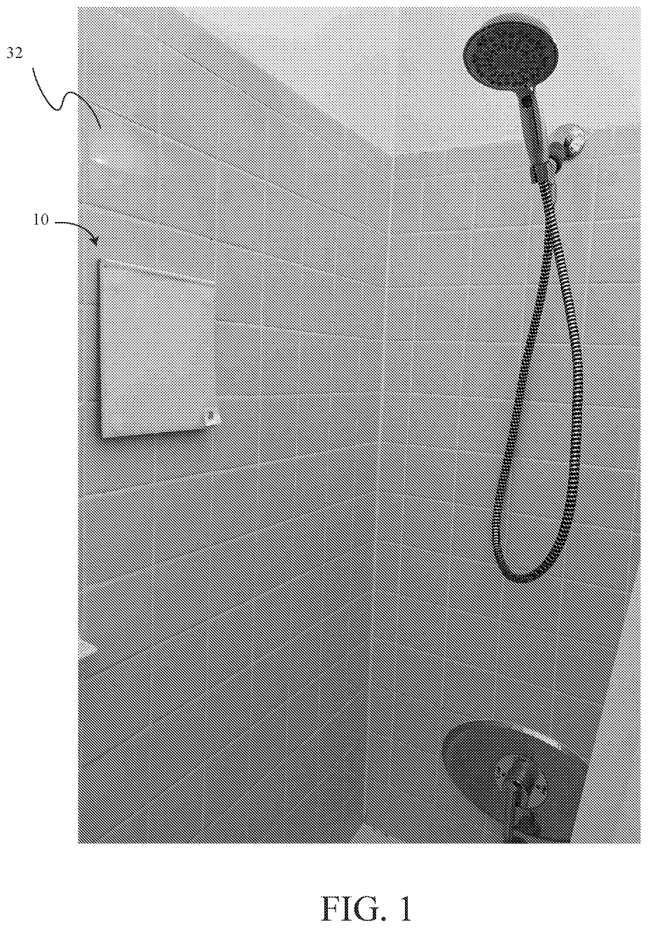

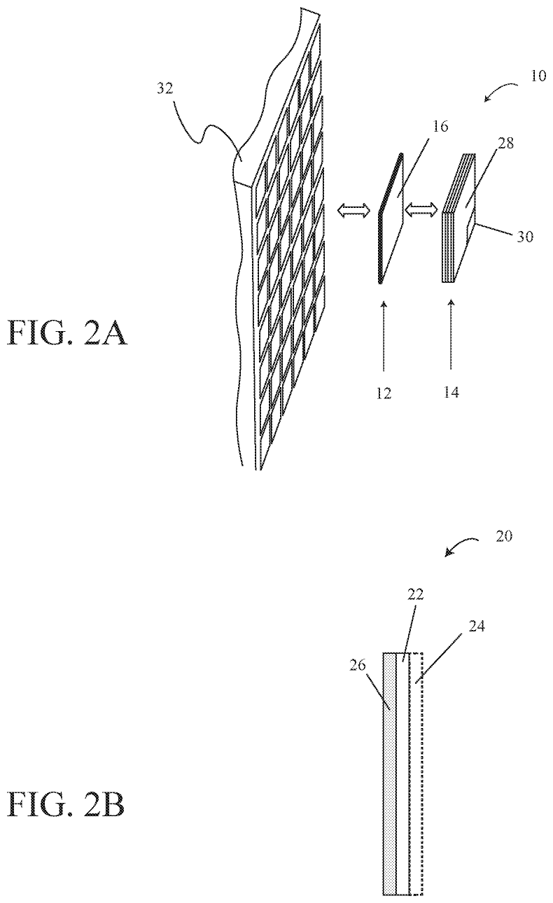

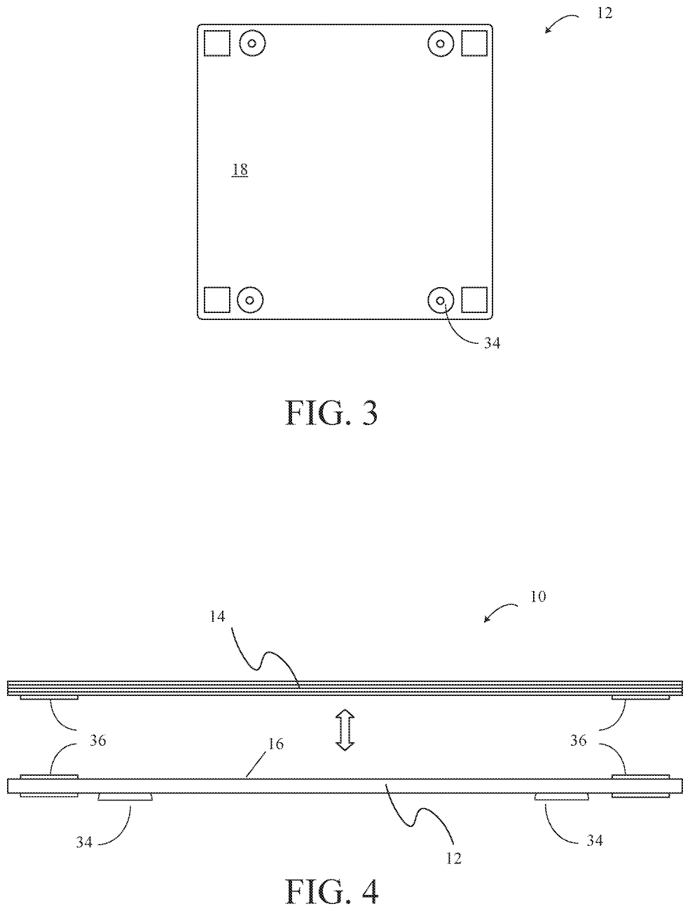

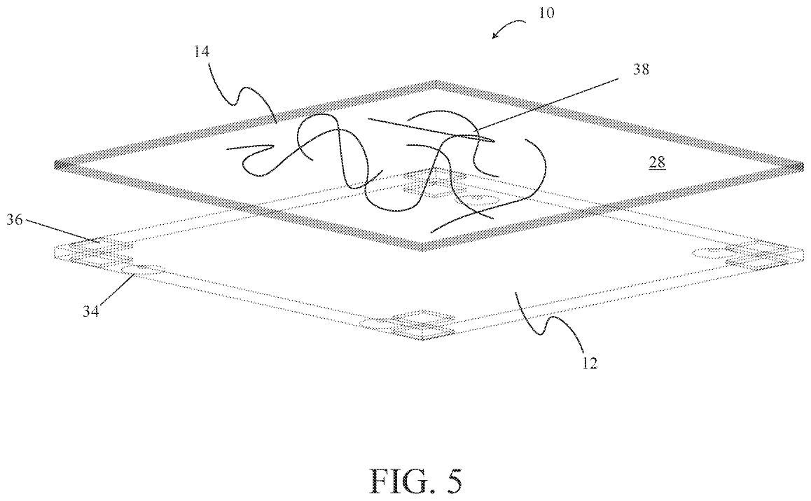

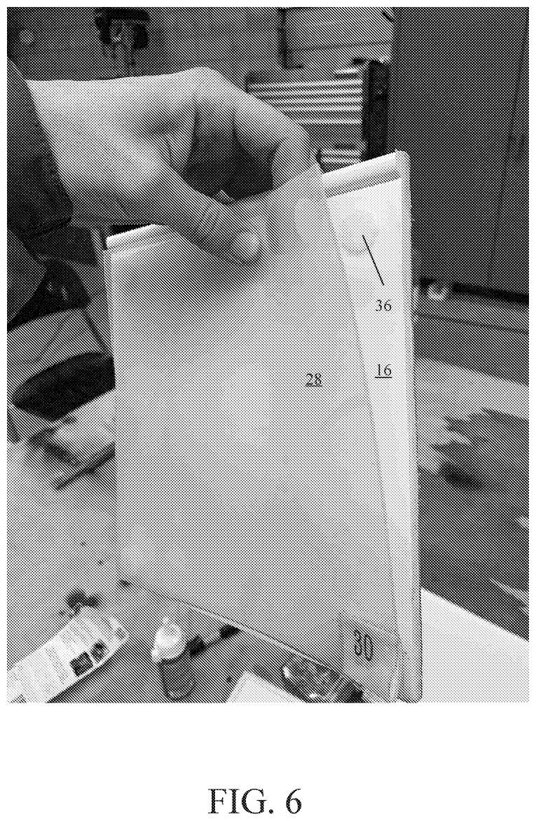

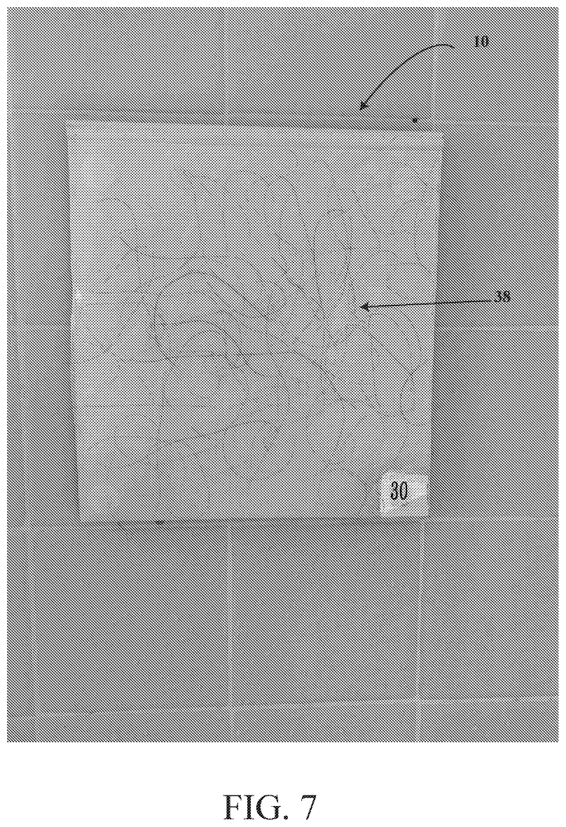

The bathroom and/or shower device illustrated in FIGS. 1-7, and therein generally designated 10, generally comprises base member 12 and hair grip device 14. In general, base member 12 may have any shape sufficient to provide the functionality described herein. In one or more embodiments, base member 12 is a flat, rigid/semi-rigid, square or rectangular member having a front/first side 16 and a back/second side 18. In some embodiments, base member 12 is dimensioned as a roughly 12″×12″ member. Generally, base member 12 may be fashioned from any material sufficient to provide the functionality described herein. In one or more embodiments, base member 12 is a made from plastic, wood, glass, ceramic, metal, composite or bamboo material. In one or more preferred embodiments, base member 12 is made from vinyl or bamboo composite material.

In one or more embodiments, hair grip device 14 is affixed to the front side 16 of base member 12. Hair grip device 14 is generally any device sufficient to provide the functionality described herein. In some embodiments, hair grip device 14 comprises a plurality of adhesive sheets 20, wherein each of the sheets has a base sheet 22 having a first side coated with a pressure sensitive adhesive layer 24 and a second side coated with a release agent 26. In one or more embodiments, base sheet 22 is comprised of any substrate suitable to act as a support for adhesive layer 24 and release agent 26. In some embodiments, base sheet 22 is a plastic sheet (e.g., nylon, acrylic, vinyl, polyester, hdpe). In other embodiments, base sheet 22 is a paper sheet.

In general, adhesive layer 24 and release agent 26 may be any pressure sensitive adhesive and release agent, respectively, sufficient to provide the functionality described herein. Adhesive layer 24 is selected and coated to a depth onto base sheet 22 such that it is capable of retaining wet hair shafts that are depressed onto its surface by a user in a shower environment. In some embodiments, adhesive 24 is a rubber, vinyl ether, acrylic, styrene block copolymer, silicone, or nitrile-based pressure sensitive adhesive. Release agent 26 is chosen and coated in a layer onto base sheet 22 in such a manner sufficient to releasably affix the base sheet onto the adhesive layer of the adjacent layer in the stack (described below). In some embodiments, release agent 26 is a silicone, vinyl carbamate, vinyl acrylic copolymer, fluoro-acrylate, modified polyurethane or starch-based release agent.

In one or more embodiments, hair grip device 14 comprises a plurality of adhesive sheets 20 arranged in a stack (releasably affixed to each other in a front to back arrangement to form a stack) and having a top surface 28 and a bottom surface (not shown). In some embodiments, the number of adhesive sheets is between 20 and 300 sheets; in others, the number is between 50 and 200; in others, between 75 and 150. As may be appreciated, top surface 28 of the stack comprises the first side of the first adhesive sheet 20 of the stack. In one or more embodiments, each adhesive sheet 20 is provided with a tabbed portion 30 to provide a user with an area to grip each adhesive sheet 20. In some embodiments, tabbed portion 30 is relatively small area on the first side (adhesive surface) of each adhesive sheet that does not contain adhesive and/or has a non-tacky material (e.g., paper, plastic) affixed to the adhesive surface, and that permits an easy user grip on each individual sheet.

In operation, base member 12 is attached/affixed to surface 32, e.g., a bathroom or shower wall surface. Generally, any suitable means of temporary or permanent attachment may be utilized. In some embodiments, suction cups 34 are fixed to the back side of base member 12 and provide the means of temporary attachment. Likewise, hair grip device 14 is attached/affixed at its bottom surface to front side 16 of base member 12. Generally, any suitable means of temporary or permanent attachment may be utilized. In some embodiments, one or more complementary Velcro® pads 36 located on the bottom surface of hair grip device 14 and on the front side 16 of base member 12 are utilized. In some alternative embodiments, adhesive or mating clasps, etc., may be utilized.

In general, a user may utilize device 10 along the following lines. A user may affix base member 12 to a bathroom/shower surface 32. If no adhesive hair grip device 14 (e.g., no stack of adhesive sheets 20) is present or is depleted, a user affixes/installs a new hair grip device 14 to base member 12. For example, a user may affix a new stack of adhesive sheets 20 to base member 12. Then, upon taking a shower and/or otherwise combing their hair and obtaining hair shafts 38 in hand by, e.g., grooming oneself, a user may depress the hair shafts onto the hair grip device 14 (e.g., the top surface 28 of the top adhesive sheet 20) and thereby transfer the hair shafts 38 onto the hair grip device. Afterwards (for example after concluding the shower), the user may easily dispose of the hair shafts 38 by, e.g., removing the top adhesive sheet 20 and discarding it. In practice, the tabbed portion 30 may be used to easily grip the relevant adhesive sheet for removing and discarding it.

The present disclosure describes and illustrates one or more novel embodiments of shower device for grooming hair. It should be understood that aspects, features or functions that are described in relation to an embodiment are not necessarily limited to the embodiment described, but rather may be applicable to one or more embodiments, unless expressly described otherwise. Also, the description set forth herein is not to be construed as limited to the embodiments shown. Rather, it is appreciated that various modifications may occur to those skilled in the art that, while not specifically set forth herein, are nevertheless within the spirit and scope of the description. When an embodiment is described as “exemplary” (or similarly) herein, it is to be understood as one non-limiting example embodiment and does not preclude other embodiments that may not include the limitations described in the exemplary embodiment.

We claim:

1. A bathroom accessory comprising:
a base member having a front side and a back side, wherein the back side is configured to attach to a surface; and
a hair grip device affixed to the front side of the base member,
wherein the hair grip device comprises a plurality of adhesive sheets,
wherein each of the plurality of adhesive sheets has a first side coated with a pressure sensitive adhesive and a second side coated with a release agent,
wherein the pressure sensitive adhesive is capable of retaining a wet hair shaft that is depressed onto it,
wherein the plurality of adhesive sheets are placed together in a front-to-back fashion, forming a stack having a top surface and a bottom surface, and
wherein the top surface of the stack comprises the first side of the top-most adhesive sheet in the stack.

2. The bathroom accessory of claim 1 wherein the surface is a shower wall.

3. The bathroom accessory of claim 2 wherein each of the plurality of adhesive sheets has a tabbed portion for gripping the adhesive sheet.

4. The bathroom accessory of claim 1 wherein the pressure sensitive adhesive is selected from a group consisting of rubber, vinyl ether, acrylic, styrene block copolymer, silicone, and nitrile-based pressure sensitive adhesives.
